(19) United States
(12) Patent Application Publication
(10) Pub. No.: US 2014/0104239 A1
(43) Pub. Date: Apr. 17, 2014

(54) METHODS AND PRODUCTS FOR INFLUENCING THE REPRESENTATION OF PICTORIAL INFORMATION BY A DISPLAY DEVICE OF AN INFORMATION TECHNOLOGY APPARATUS

(71) Applicant: Thomas Lederer, Herrsching (DE)

(72) Inventor: Thomas Lederer, Herrsching (DE)

(73) Assignee: UNIFY GMBH & CO. KG, Muenchen (DE)

(21) Appl. No.: 14/124,904

(22) PCT Filed: Jun. 21, 2011
(86) PCT No.: PCT/EP2011/003075

§ 371 Date: Dec. 9, 2013

(51) Int. Cl. G06T 3/00; G06F 3/01

(52) U.S. Cl. CPC G06T 3/0006; G06F 3/017
USPC 345/175

(57) ABSTRACT

In a method for influencing the representation of pictorial information by a display device (2) of an information technology apparatus (1) by a user of said information technology apparatus with the aid of a movement of a body part of said user, the representation of the pictorial information is subjected to a transformation from a set of transformations comprising translations, rotations, compressions and/or expansions and/or combinations of these transformations. The direction of the transformation is determined by the initial direction of the movement of the body part and, until the reception of a signal defined for this purpose by the information technology apparatus, is not changed even when the direction of the movement of the body part deviates from the initial direction of the movement of the body part.

### CROSS REFERENCE TO RELATED APPLICATIONS

This application is the U.S. national phase under 35 U.S.C. §371 of PCT international application no. PCT/EP2011/003075, filed on Jun. 21, 2011.

### BACKGROUND OF THE INVENTION

1. Field of the Invention

Embodiments relate to methods and apparatuses intended to influence the representation of pictorial information by a display device.

### BACKGROUND OF THE RELATED ART

Known user interfaces for IT apparatuses, such as Smartphones, are frequently operated through the use of so-called touch screens, i.e. touch-sensitive display devices. For example, so-called swiping gestures are used to vertically scroll through lists or horizontally page between various views (e.g. in a picture gallery). This frequently involves movements of a hand or finger of the user of such an apparatus. Due to the limited size of these apparatuses, there are frequently restrictions on how far one can page. To continue scrolling or paging, the swiping gesture must be interrupted and the finger must be repositioned to repeat the gesture.

### BRIEF SUMMARY OF THE INVENTION

The invention envisions a method for a user of an IT apparatus to influence the representation of pictorial information by an IT apparatus's display device by moving a part of his body, wherein the representation of pictorial information is subjected to a transformation from among a set of transformations, including translation, rotation, compression and/or expansion and/or a combination of these transformations. The direction of the transformation is determined by the initial direction of the movement of the body part. Until a signal defined for this purpose is received by the IT apparatus, the direction of the transformation is not changed even if the direction of the movement of the body part deviates from the initial direction of the movement of the body part.

### BRIEF DESCRIPTION OF THE DRAWINGS

FIG. 1 a schematic diagram of an information technology apparatus according to the invention showing a preferred embodiment of the invention;

FIG. 2 a schematic diagram of an information technology apparatus according to the invention showing a preferred embodiment of the invention;

FIG. 3 a schematic diagram of an information technology apparatus according to the invention showing a preferred embodiment of the invention;

FIG. 4 a schematic diagram of an information technology apparatus according to the invention showing a preferred embodiment of the invention;

FIG. 5 a schematic diagram of an information technology apparatus according to the invention showing a preferred embodiment of the invention;

FIG. 6 a schematic diagram of an information technology apparatus according to the invention showing a preferred embodiment of the invention;

FIG. 7 a schematic diagram of an information technology apparatus according to the invention showing a preferred embodiment of the invention;

FIG. 8 a schematic diagram of an information technology apparatus according to the invention showing a preferred embodiment of the invention;

FIG. 9a a schematic diagram of an information technology apparatus according to the invention showing a preferred embodiment of the invention;

FIG. 9b a schematic diagram of an information technology apparatus according to the invention showing a preferred embodiment of the invention;

FIG. 10a a schematic diagram of an information technology apparatus according to the invention with a preferred embodiment of the invention;

FIG. 10b a schematic diagram of an information technology apparatus according to the invention showing a preferred embodiment of the invention;

FIG. 11 a schematic diagram of an information technology apparatus according to the invention showing a preferred embodiment of the invention;

FIG. 12 a schematic diagram of an information technology apparatus according to the invention showing a preferred embodiment of the invention;

FIG. 13 a schematic diagram of an information technology apparatus according to the invention showing a preferred embodiment of the invention;

FIG. 14 a schematic diagram of an information technology apparatus according to the invention showing a preferred embodiment of the invention.

### DETAILED DESCRIPTION OF THE INVENTION

In connection with the description of this invention, an IT apparatus, hereinafter also occasionally referred to as an apparatus for the sake of brevity, means a product that is at least equipped and configured to display data, but preferably also to process, store, receive, and send data. Important examples of such IT apparatuses are computers, communications terminals, and consumer electronics devices.

In this context, a display device means a device used to display pictorial information. Important examples of such display devices are screens or displays based on various technologies, such as LCD or LED displays or display devices based on other technologies. The apparatus' display device is preferably designed to be touch-sensitive (a so-called “touch screen”) so that the user can also use the display device as an input device by tapping or just touching at least one position on the display device with at least one finger or with a stylus, or by swiping the display device with at least one finger or with a stylus.

In this context, pictorial information means information that can be displayed to a user, preferably in the form of a two-dimensional image. These preferably two-dimensional images are preferably but not necessarily planar. Important examples of such images are digital images, which consist of a matrix of pixels. Images in this sense also include vector graphics and texts and all types of information that can be displayed to the user as an image by the known display devices of today's computers and other information technology apparatuses or in any other way.

In this context, influencing the representation of pictorial information by a display device of an IT apparatus by a user of the IT apparatus with the aid of the movement of a part of the user's body means any process by which the representation of pictorial information by a display device of an IT apparatus is influenced by a user of this IT apparatus with the aid of the movement of a part of the user's body. Important examples of such processes are so-called “zooming” or “scrolling” of the display device or the information represented on the display device. Zooming decreases/compresses (“zoom out”) or increases/expands (“zoom in”) the size of the information represented. Scrolling sifts through the information represented. Zooming and scrolling are important examples of transformations of the representation of pictorial information by a display device of an IT apparatus.

Depending on the type of display device and whether the display device can also serve as an input device, the representation of pictorial information by the display device may be influenced, for example, by the fingers or a stylus guided by the fingers, or with the aid of a pointing device, such as a mouse, or by a combination of the above and/or other techniques for influencing the representation of pictorial information by a display device of an IT apparatus by a user of this IT apparatus with the aid of the movement of a part of the user's body.

In this context, a transformation of the representation of pictorial information by a display device of an IT apparatus means a change in the representation of pictorial information by a display device of an IT apparatus. Important examples of such transformations are scrolling or zooming, or translation, rotation, compression and/or expansion and/or any combination of these transformations.

In this context, a set of transformations, comprising translations, rotations, compressions and/or expansions and/or any combinations of these transformations means a set of such transformations comprising all conceivable transformations that can be executed on a display device or some of the conceivable transformations that can be executed on a display device. Thus a set of rotations can, for example, be limited to rotations at a right angle. Some transformations can be described by the value or values of typical parameters or groups of parameters for these transformations. Examples of such transformations are translations that can be characterized by a displacement vector. Other examples are rotations that can be described by a pivot point and an angle of rotation, or by giving a pivot point and a normal vector whose length indicates the angle of rotation. Compressions or expansions can be described by indicating the expansion or compression factor or a set of such expansion or compression factors.

In this context, the direction of such a transformation means a parameter characterized by a vector or a sign. Important examples of such directional parameters are displacement vectors, normal vectors, or the unit vectors appurtenant to them, directions of rotation (“to the left or to the right”), or the direction of an expansion or compression, or the ratio of the expansion or compression factors assigned to the two Cartesian axes of an image plane, or other similar variables.

In this context, the initial direction of the movement of the part of the user's body means the direction of movement of the body part that characterizes the movement at the start of the movement. An important example of an initial direction of the movement of a part of the user's body is the initial displacement vector, i.e., the tangential vectors of the trajectory of the movement at its starting point. Another important example of an initial direction of the movement of a part of the user's body is the initial direction of rotation of the trajectory of a movement around a point. To determine the direction of a transformation of the representation of pictorial information by a display device of an information technology apparatus by the initial direction of the movement of a part of a user's body, the initial direction of the movement of the user's body part is recorded by the IT apparatus, with the aid of an input device, if available, preferably with the aid of a pointing device, such as a mouse or a touch-sensitive display device. With the aid of the type of program “running on the apparatus” (the so-called “application”), the recorded initial direction of movement is assigned a directional parameter, i.e., “the direction” of the transformation, which is to be controlled by the recorded body movement.

For example, if the user makes a body movement in order to scroll through a list that is not fully displayed on the display device, which results in moving a mouse along a trajectory guided by his hand, the direction of the transformation to be made—in this case, the direction of the scrolling—preferably corresponds to the tangential vector of the trajectory at the starting point of the movement measured by the IT apparatus or preferably to a digital approximate value for this tangential vector or preferably to a projection of this tangential vector on one of the Cartesian axes of a two-dimensional plane, which the IT apparatus identifies with the image plane of the display device, based on the “software running on it.”

A digital approximate value for an initial direction of movement can be determined by operations with temporal and/or spatial discretizations. Thus an initial displacement vector can preferably be determined as the difference vector between two pixels through which the trajectory of a mouse cursor or the contact point of the finger of a user passes at two consecutive points in time in the starting phase of the movement.

In this context, a signal defined for this purpose is a signal by which the user of an apparatus according to the invention signals to this apparatus and/or to software running on this apparatus that, as of this moment, the initial direction will no longer be the direction of further transformation or of an additional transformation to be executed, but that the user will specify a new direction. This can be any signal that the user generates with the aid of an action in connection with a feature of the IT apparatus or with the aid of an external apparatus. Preferred examples of such signals are so-called mouse clicks, the signals elicited by lifting the finger from a touch-sensitive display device or other similar actions.

A preferred embodiment of the invention, whose features can also be combined with the features of other embodiments, envisions a method by which the transformation of the representation is continued, as long as the movement of the body part continues, until the signal defined for this purpose is received by the IT apparatus. If, for example, a user of an IT apparatus wishes to scroll to a remote section of a document displayed to him using this embodiment, then, after an initial swiping gesture in the direction of the remote section of the document, the user need only move his finger or a stylus or a mouse in any direction for the scrolling process to continue until the desired section is displayed. Since, according to the invention, only the initial direction of movement influences the direction of the scrolling, any movements the user makes after determining the initial direction are irrelevant. It is not necessary to repeatedly remove and reposition the finger or the stylus. This means that work can be done with greater speed with such IT apparatuses.

Another preferred embodiment of the invention, whose features can also be combined with the features of other embodiments, envisions a process in which the speed of the transformation is a monotonic function of the speed of the movement of the body part. In these embodiments of the invention, the transformation of the representation proceeds faster, the faster the user moves his body, and slower, the slower the user moves his body. Preferentially, the speed of the transformation is proportionate to the speed of the movement of the body part. With some embodiments, the proportionality factor can depend on the distance of the finger, stylus or mouse cursor from the center of the display device and is preferentially greater, the greater the distance.

Another preferred embodiment of the invention, whose features can also be combined with features of other embodiments, envisions a method in which the display device of the apparatus is touch-sensitive and the representation of pictorial information by this display device can be influenced by the movement of at least one of the user's fingers touching the display device or with the aid of at least one stylus touching the display device and moved by the user's body.

Another preferred embodiment of the invention, whose features can also be combined with features of other embodiments, envisions a method in which the representation of pictorial information by this display device can be influenced by the movement of a pointing device by the user's body, particularly a mouse.

Another preferred embodiment of the invention, whose features can also be combined with features of other embodiments, envisions a method in which the repositioning of a part of the user's body, particularly a finger, or the repositioning of a stylus or a pointing device, particularly a mouse, by the user's body is a defined signal for the purpose of changing the direction of the transformation. In these embodiments of the invention, a change in the direction of the transformation of the representation is preferably signaled by a break in the trajectory of the movement. This is preferably accomplished by lifting the finger, the stylus, or the mouse, or by pressing a key with a stylus or a mouse, or some other similar action. With other embodiments of the invention, the signal to change the direction of the transformation is generated with the aid of other input devices, such as a foot switch or a microphone.

Another preferred embodiment of the invention, whose features can also be combined with features of other embodiments, envisions a method in which the pictorial information is represented in the form of a list, which cannot be fully displayed at the given resolution due to its length.

According to the invention, an information technology apparatus is also envisioned with a display device to implement a method according to the invention, preferably according to one of the aforementioned illustrative embodiments of the invention.

Another preferred embodiment of the invention, whose features can also be combined with features of other embodiments, envisions an IT apparatus with a processing device, a storage device, and a program stored in the storage device and executable by the processing device to implement a method according to the invention, preferably according to one of the aforementioned illustrative embodiments of the invention.

The invention also envisions a pointing device, particularly a mouse or a stylus, with a device to send a defined signal for the purpose of changing the direction of a transformation to an information technology apparatus according to the invention, in association with a method according to the invention and preferably according to one of the aforementioned illustrative embodiments of the invention.

In this context, a pointing device means a device with which a user of an IT apparatus can generate signals that inform the IT apparatus of the movements of a part of the user's body. Important examples of such pointing devices are the mouse (computer mouse), the so-called “touchpad,” a touch-sensitive input device that is preferably integrated into the IT apparatus, or other similar devices.

In this context, a repositioning of a part of the user's body means an action by the user that precedes the generation of a signal or that generates a signal by which the user of an apparatus according to the invention signals to this apparatus and/or to software running on this apparatus that, from this time forward, the initial direction will no longer be the direction of further transformation or of an additional transformation to be executed, but that a new direction will be specified by the user. A preferred repositioning in this sense is removing or lifting a finger or a stylus or some other similar input device from a touch-sensitive display device, a touchpad, or a similar support.

The body movement that controls the transformation of the representation is preferably interrupted for repositioning and then continued, after the repositioning, such that the initial direction of the movement is re-determined and used as the basis for further control of the representation. With embodiments of the invention wherein the user wishes to bring about a translation of the information being represented—i.e. “scrolling”—the scrolling direction is re-determined after the repositioning, i.e., preferably after removing or lifting the finger, stylus, or pointer, and the scrolling direction is changed if the initial direction of the movement after the repositioning does not match the initial direction of the movement before the repositioning.

In this context, a list means an information technology document (i.e., a file), preferably containing text, which contains a number of items (or entries), which are preferably arranged in lines below each other or side by side in matrix form in the document.

Depending on the selected embodiment, this invention can have the advantage of making it possible to scroll down lengthy lists by “swiping” with a finger, stylus, or mouse without repositioning between two swipes. Moreover, the speed of the swipe can be recorded and taken into account so that the user can scroll up or down a greater distance. Thus, the scrolling precision can be improved. The invention makes special scroll buttons or bars on the border of the display device or window unnecessary.

To scroll vertically or horizontally through lengthy lists, an embodiment of the invention can be used by which the movement through the list has a 1:1 correspondence with the path of the swiping movement with the finger, stylus, or mouse. The swiping gesture is preferably initiated by touch and movement, so that the scrolling direction is based on the initial direction of the movement. Further scrolling will be initiated at a point in time (T1) or after a particular distance (S1), preferably by a movement in some direction. Thus, for example, after a particular point in time (T1) or a particular distance (S1), depending on the chosen embodiment of the invention, the user can continue scrolling without repositioning his finger, e.g., by back and forth swiping gestures or by circular motions. If the scrolling direction is to be changed, an interruption suffices, i.e., the touch is briefly interrupted and the finger is repositioned.

Another preferred embodiment of the invention, whose features can also be combined with features of other embodiments, envisions a method in which two-fingered gestures can be used. When applied to zooming, a so-called pinching gesture (i.e., pressing two fingers together or opening them up) initiates a zoom-in or zoom-out action. Thereafter, a touch and movement of one finger is all that is necessary to continue zooming. The direction of the movement is again irrelevant.

Another preferred embodiment of the invention, whose features can also be combined with features of other embodiments, envisions a method in which rotating gestures (e.g., for rotating an image or a figure) can be used. These gestures are also preferably initiated with two fingers, which initially make a rotating movement in this case. Thereafter, the rotation is continued, preferably with one finger, and preferably by a movement in any direction.

Another preferred embodiment of the invention, whose features can also be combined with features of other embodiments, envisions a method in which three-fingered gestures are used, which can also be applied in a similar manner to page-scrolling gestures with three fingers.

These embodiments of the invention have the advantage that the user can scroll through vertical or horizontal lists on touch screens without stopping the swiping movement, which enables more efficient operation of the IT apparatus.

The following example illustrates this: To scroll up and down a 25-cm-long list on a 5-cm touch screen using conventional swiping gestures, the user must use his finger, a stylus, or a mouse to cover a distance of about 20 cm of swipes plus 15 cm of movements (without touching) for repositioning purposes, which results in 35 cm of movement, including 3 repositionings. With the appropriate embodiment of this invention, only 20-cm-long swiping movements are needed without further repositioning.

The process can also be used to scroll on a PC (e.g., a laptop) with a mouse or a touchpad.

The invention is described in more detail below, using figures and preferred illustrative embodiments.

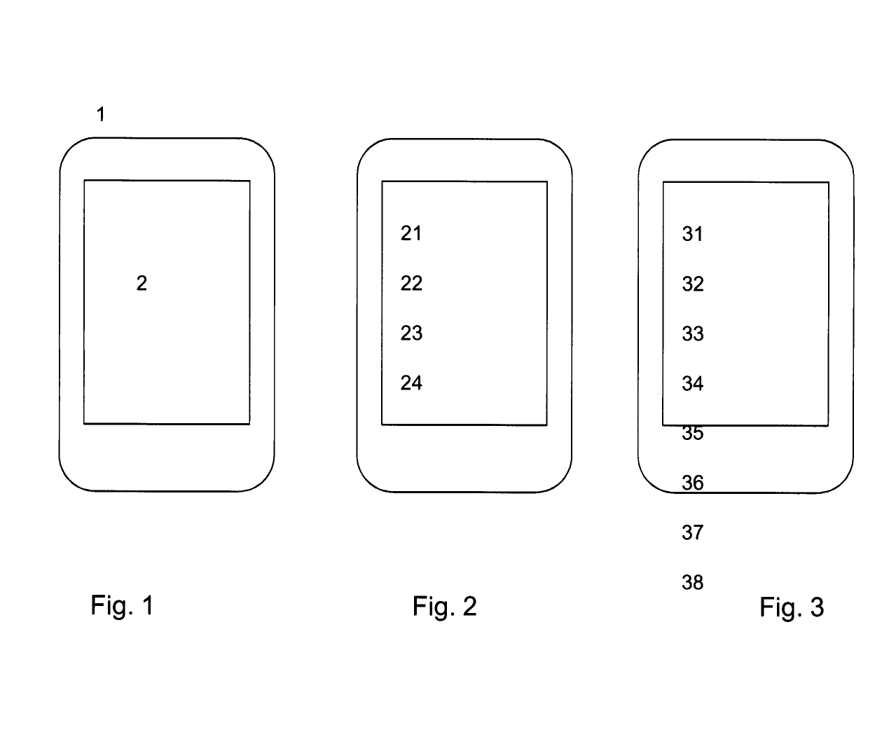

A schematic diagram of an information technology apparatus according to the invention (1) with a display device (2) is shown in FIG. 1. In FIG. 2, the display device of this IT apparatus displays a list with entries 21, 22, 23 and 24. As shown in FIG. 3, this list has a number of entries 35, 36, 37 and 38 which cannot be displayed by the display device—at least at the current resolution on the display device.

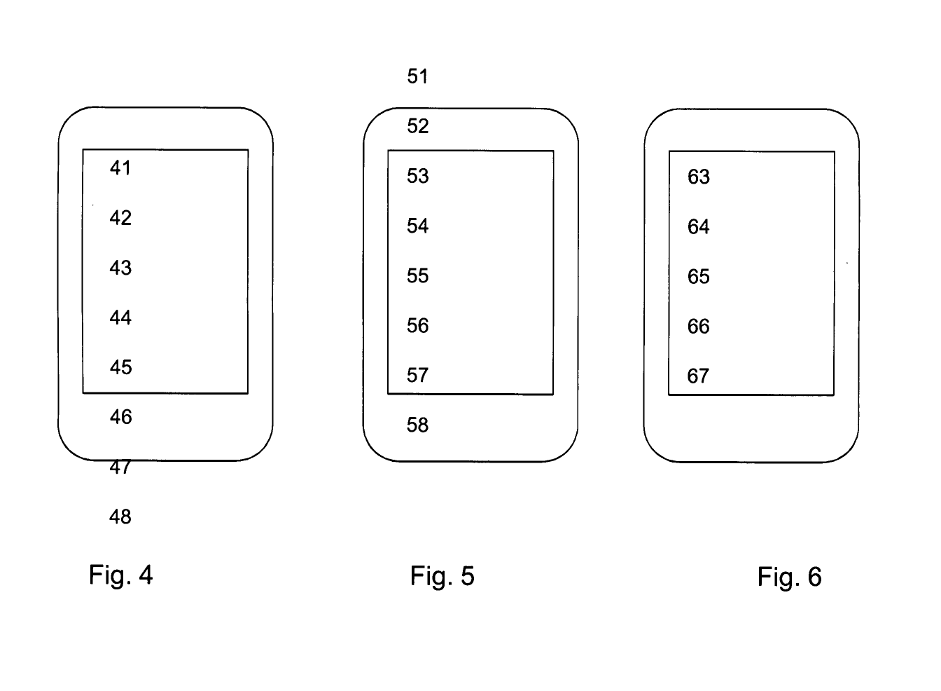

In FIG. 4, the IT apparatus is shown in a state in which the list has been scrolled up, so that the five entries 41, 42, 43, 44 and 45 on the list can now be shown on the display device. In FIG. 5, the IT apparatus is shown in a state in which entries 51 and 52 are outside of the section shown by the display device. In this state, the user is offered the image shown in FIG. 6.

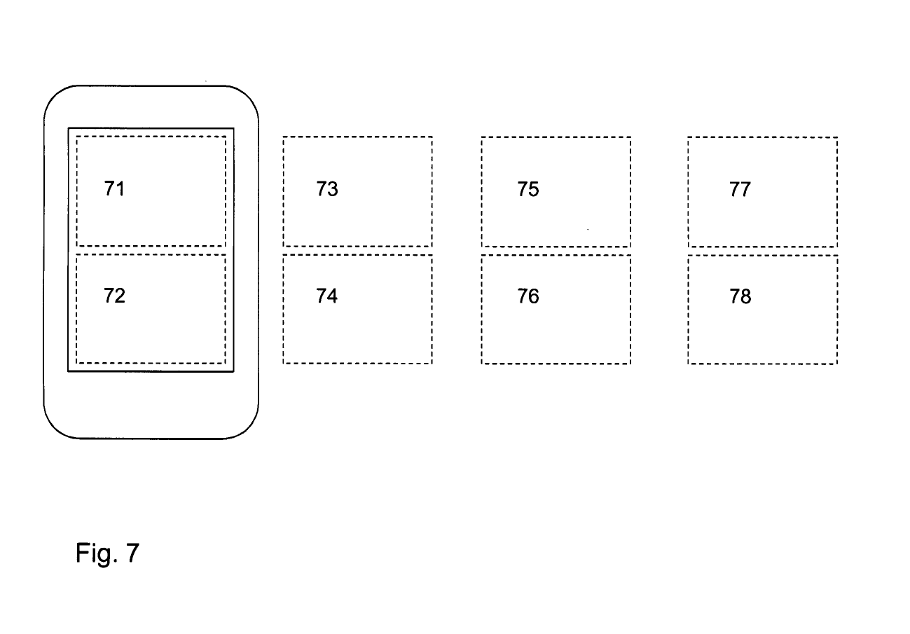

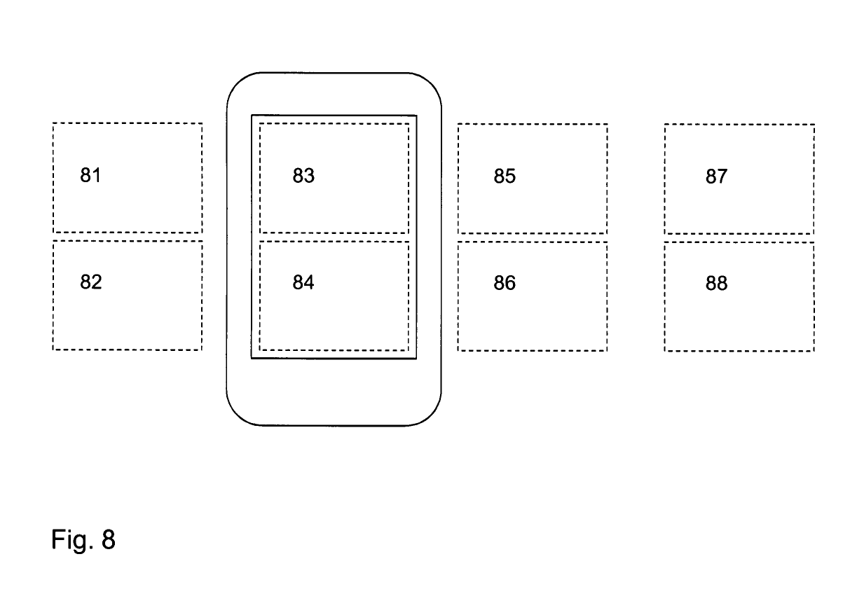

FIG. 7 shows the IT apparatus in a state in which the display device is showing images 71 and 72 of an image gallery containing images 71-78. FIG. 8 shows the IT apparatus after the image gallery has been scrolled to the right so that the display device is now showing images 83 and 84.

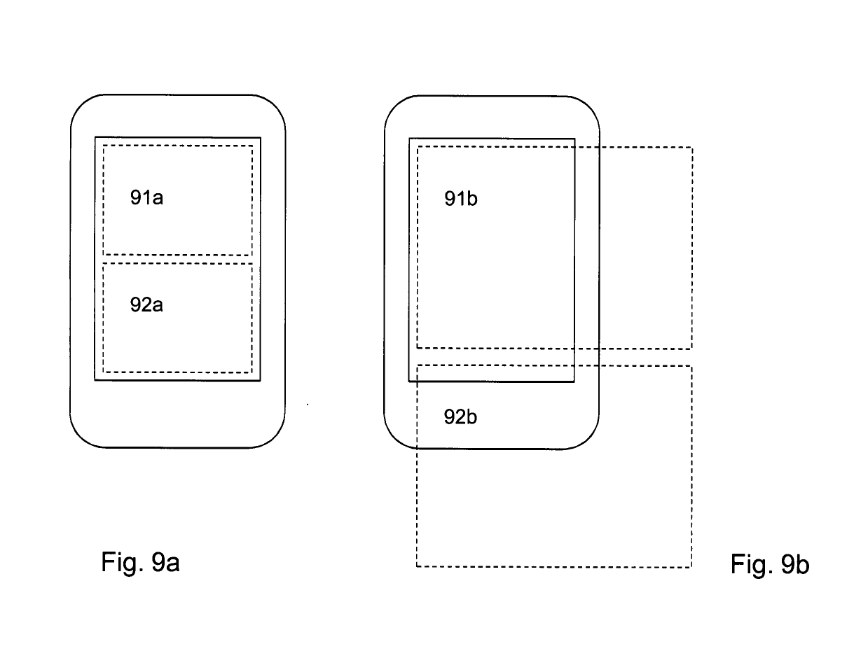

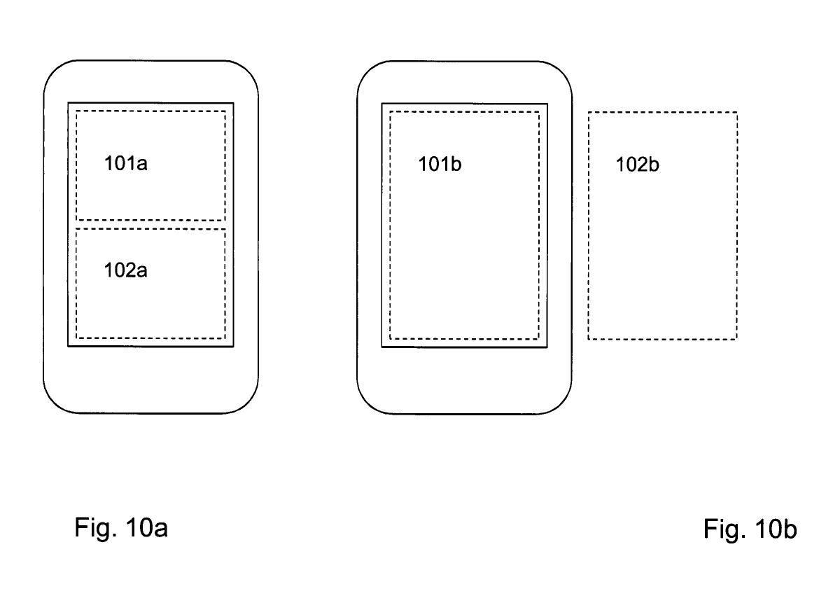

FIG. 9B shows the IT apparatus in a state in which images 91a and 92b in FIG. 9A have been enlarged so that the display device is showing only a section of the images, 91b and 92b. FIG. 10B shows the IT apparatus in a state in which image 101A in FIG. 10A has been enlarged and rotated 90°. After the enlargement and rotation, image 102A of FIG. 10A is outside of the display area of the display device

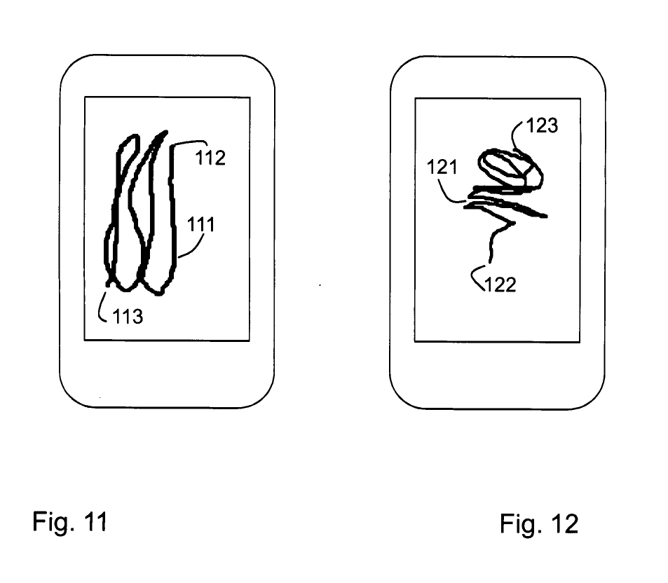

FIGS. 11 and 12 show the IT apparatus with two sample representations of a trajectory (111 and 121) of the movement of the touch point of a user's finger or a stylus or mouse cursor or other similar feature of an input device guided by the user's finger, wherein this sample trajectory runs from point 112 or 122 to point 113 or 123. Starting from point 112 or 122, the movement is initially downward or upward. Regardless of the further course of the trajectory, the transformation of the representation of pictorial information on the display device initiated by the initial movement continues in the direction defined by the initial movement.

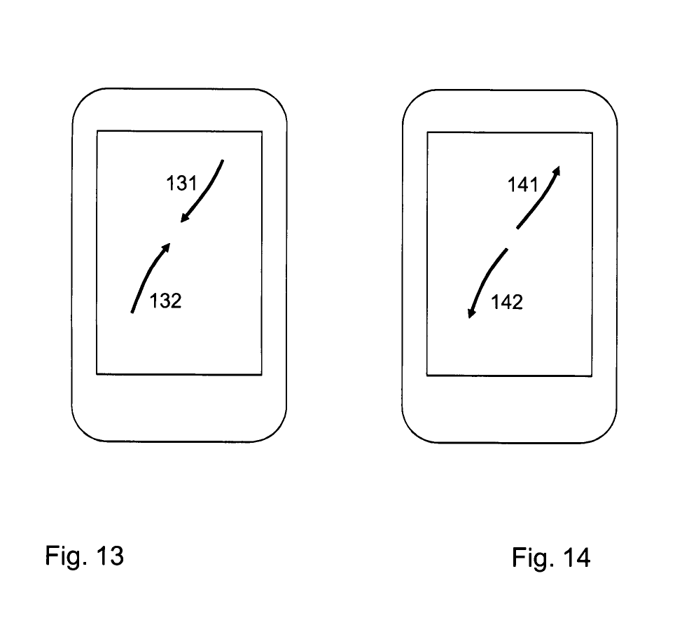

FIGS. 13 and 14 show the IT apparatus with two sample representations of trajectories (131 and 132 and 141 and 142) of the movement of the touch points of a user's two fingers, wherein these trajectories correspond to a pinching gesture, i.e., pressing two fingers together or spreading them apart, which can initiate a zoom-in or zoom-out transformation of the representation of pictorial information on the display device.

We claim:

1. A method for influencing a representation of pictorial information by a display device of an information technology (“IT”) apparatus by a user of the IT apparatus with aid of the movement of a part of the user's body, wherein the representation of pictorial information is subjected to a transformation from among a set of transformations, selected from the group consisting of translation, rotation, compression, expansion and combinations thereof, comprising:
a) determining a transformation direction by an initial direction of the movement of the body part; and
b) maintaining the transformation direction even if a further direction of the movement of the body part deviates from the initial direction of the movement of the body part, until a signal defined for ceasing maintenance of the transformation direction is received by the IT apparatus.

2. The method of claim 1, wherein the transformation of the representation continues for as long as the movement of the body part continues, until the IT apparatus receives a signal defined ceasing the transformation.

3. The method of claim 1, wherein the transformation has a speed that is a monotonic function of a speed of the movement of the part of the user's body.

4. The method of claim 1, wherein the display device of the IT apparatus is touch-sensitive and the representation of pictorial information by the display device is influenced by at least one of the movement of at least one of the user's fingers touching the display device and with the aid of a stylus moved by the user's body touching the display device.

5. The method of claim 1, wherein the representation of pictorial information by the display device is influenced by the movement of a pointing device by the user's body.

6. The method of claim 1, wherein the repositioning of the part of the user's body, is the defined signal for the purpose of changing the direction of the transformation.

7. The method of claim 1, wherein pictorial information is represented in the form of a list that is not fully displayed at a given resolution due to its length.

8. An information technology (“IT”) apparatus comprising a display device, said display device concluding a representation of pictoral information influenced by a user of the IT apparatus with the aid of movement of a part of the user's body, wherein the representation of pictorial information is subjected to a transformation from among a set of transformations, selected from the group consisting of translation, rotation, compression, expansion and combinations thereof,
a) determining a transformation direction by an initial direction of the movement of the body part; and
b) maintaining the transformation direction even if a further direction of the movement of the body part deviates from the initial direction of the movement of the body part, until a signal defined for ceasing maintenance of the transformation direction is received by the IT apparatus.

9. The information technology apparatus of claim 8, further comprising a processing device, a storage device, and a program stored in the storage device wherein said program is executed by a processing device to implement the representation of pictorial information.

10. A pointing device, comprising a transmitter configured to send an information technology apparatus, said information technology apparatus comprising a display device, said display device including a representation of pictoral information influenced by a user of the IT apparatus with the aid of movement of a part of the user's body, wherein the representation of pictorial information is subjected to a transformation from among a set of transformations, selected from the group consisting of translation, rotation, compression, expansion and combinations thereof,
a) determining a transformation direction by an initial direction of the movement of the body part; and
b) maintaining the transformation direction even if a further direction of the movement of the body part deviates from the initial direction of the movement of the body part, until a signal defined for ceasing maintenance of the transformation direction is received by the IT apparatus, wherein the defined signal is a signal ceasing at least one of maintenance of the transformation direction and the transformation.
